(19) United States
(12) Patent Application Publication
(10) Pub. No.: US 2024/0417254 A1
(43) Pub. Date: Dec. 19, 2024

(54) Methods for the production of thiosulfates via salt metathesis

(71) Applicant: Tessenderlo Group NV, Brussels (BE)

(72) Inventors: Thomas David Fairweather, McMinnville, OR (US); Michael Hojjatie, Tucson, AZ (US); Jorge Franco, Mesa, AZ (US)

(73) Assignee: Tessenderlo Group NV, Brussels (BE)

(21) Appl. No.: 18/696,371

(22) PCT Filed: Oct. 3, 2022
(86) PCT No.: PCT/EP2022/077482

§ 371 Date: Mar. 28, 2024

(30) Foreign Application Priority Data
Oct. 4, 2021 (EP) 21200780.1

(51) Int. Cl. C01B 17/64; C05D 3/00; C05D 5/00; C05D 9/02; C05G 5/20

(52) U.S. Cl. CPC C01B 17/64; C05D 3/00; C05D 5/00; C05D 9/02; C05G 5/20

(57) ABSTRACT

The present invention relates method for the production of a thiosulfate comprising the steps of
providing a thiosulfate A represented by formula (X)ₙ(S₂O₃)ₘ;
providing a compound B represented by formula (Y)ₒ(Z)ₚ;
contacting the thiosulfate A of step (i) with the compound B of step (ii) in the presence of a solvent, thereby obtaining a reaction mixture comprising a compound C represented by formula (X)_{q}(Z)ᵣ and a thiosulfate D represented by formula (Y)ₛ(S₂O₃)ₜ;
   wherein the ratio of the solubility of the thiosulfate D in the solvent at a predetermined temperature to the solubility of the compound C in the solvent at the same predetermined temperature is at least 5:1 or less than 1:5. The invention also relates to liquid fertilizers obtainable by the method of the invention.

### FIELD OF THE INVENTION

The present invention relates to a method for the production of thiosulfates via salt metathesis with another thiosulfate. The invention also relates to liquid fertilizers obtainable by the method of the invention.

### BACKGROUND OF THE INVENTION

Thiosulfates are the salts of thiosulfuric acid and consist of one or more cations combined with a thiosulfate (S₂O₃²⁻) anion. Thiosulfates are known compounds having various uses. For example, potassium thiosulfate (K₂S₂O₃), calcium thiosulfate (CaS₂O₃), ammonium thiosulfate ((NH₄)₂S₂O₃), magnesium thiosulfate (MgS₂O₃), and others are commonly applied fertilizers.

Various different synthetic routes towards thiosulfates exist. The most important and economically viable synthetic routes rely on SO₂ absorption in alkaline media to form a (bi)sulfite solution and reacting the (bi)sulfite with sulfur or sulfide to obtain thiosulfate (see e.g. WO2017/116773A1). Other synthetic routes rely on the production of a polysulfide from sulfur, which is oxidized to a thiosulfate using oxygen or SO₂ gas (see e.g. U.S. Pat. No. 6,984,368B2).

A disadvantage of known synthetic routes is that they require a variety of reagents and careful production knowledge and control, for example to avoid extremely hazardous SO₂ or H₂S evolution, and to avoid formation of large amounts of byproducts (sulfates, sulfites) leading to inferior products. All in all this means it is only viable to perform these processes in dedicated production plants with specialized workers. In particular the routes which rely on sulfur burning require highly specialized equipment and skills in view of the environmental, health and safety hazards involved.

It is an object of the present invention to provide a facile production method of thiosulfates.

### SUMMARY OF THE INVENTION

The present invention provides a facile production method of thiosulfates wherein a desired thiosulfate D is produced from a different thiosulfate A and a compound B by salt metathesis reaction, resulting in a counterion exchange, thereby forming the desired thiosulfate D and compound C, wherein the solvent and reagents are such that a significant solubility difference exists between thiosulfate D and compound C, allowing an easy separation by solid-liquid separation techniques. Such a method has several advantages, for example it is facile to operate, without significant environmental, health and safety hazards. It also does not require specialized equipment, but can be performed in a simple stirred tank reactor. Hence, the thiosulfate A can be produced in highly efficient, large-scale dedicated production plants, and converted to the desired thiosulfate D, at the same facility or at a remote location on an as-needed basis. This avoids the need to shut down a large plant (which is often in continuous production mode) to produce small amounts of another thiosulfate, as well as avoids complicated permit procedures since the salt metathesis reaction of the invention does not result in e.g. hazardous emissions.

In a first aspect of the present invention there is thus provided a method for the production of a thiosulfate comprising the steps of
(i) providing a thiosulfate A represented by formula (X)ₙ(S₂O₃)ₘ;
(ii) providing a compound B represented by formula (Y)ₒ(Z)ₚ;
(iii) contacting the thiosulfate A of step (i) with the compound B of step (ii) in the presence of a solvent, thereby obtaining a reaction mixture comprising a compound C represented by formula (X)_{q}(Z)ᵣ and a thiosulfate D represented by formula (Y)ₛ(S₂O₃)ₜ;
wherein the ratio of the solubility of the thiosulfate D in the solvent at a predetermined temperature to the solubility of the compound C in the solvent at the same predetermined temperature is at least 5:1 or less than 1:5;
wherein n, m, o, p, q, r, s and t are each an integer individually selected from 1, 2, 3 and 4;
wherein X represents one or more cations with charge number +1, +2 or +3 and n and m are such that the overall charge of thiosulfate A is zero;
wherein Y represents one or more cations with charge number +1, +2 or +3, Z represents one or more anions with charge number −1, −2, or −3 and o and p are such that the overall charge of compound B is zero;
wherein X and Y are different;
wherein q and r are such that the overall charge of compound C is zero; and
wherein s and t are such that the overall charge of thiosulfate D is zero.

In another aspect of the invention there is provided a liquid fertilizer preferably obtainable by the method described herein, comprising:
more than 10 wt. % (by total weight of the fertilizer) of the thiosulfate D, preferably more than 15 wt. %, most preferably more than 20 wt. %;
0.01-4 wt. % (by total weight of the fertilizer) of the thiosulfate A, preferably 0.1-4 wt. %, more preferably 0.5-3.5 wt. %, most preferably 1-3 wt. %, and
at least 50 wt. % (by total weight of the fertilizer solvent, preferably at least 65 wt. %.

### DETAILED DESCRIPTION

The expression “comprise” and variations thereof, such as, “comprises” and “comprising” as used herein should be construed in an open, inclusive sense, meaning that the embodiment described includes the recited features, but that it does not exclude the presence of other features, as long as they do not render the embodiment unworkable.

The expressions “one embodiment”, “a particular embodiment”, “an embodiment” etc. as used herein should be construed to mean that a particular feature, structure or characteristic described in connection with the embodiment is included in at least one embodiment. Thus, the appearances of such expressions in various places throughout this specification do not necessarily all refer to the same embodiment. Furthermore, the particular features, structures, or characteristics may be combined in any suitable manner in one or more embodiments. For example, certain features of the disclosure which are described herein in the context of separate embodiments are also explicitly envisaged in combination in a single embodiment.

The singular forms “a,” “an,” and “the” as used herein should be construed to include plural referents unless the content clearly dictates otherwise. It should also be noted that the term “or” is generally employed in its broadest sense, that is as meaning “and/or” unless the content clearly dictates otherwise.

The expression “potassium (as K₂O)” when used in relation to the potassium content is known to the skilled person and should be construed to mean the potassium content as expressed in terms of the amount of K₂O which would provide the same amount of potassium as provided by whichever potassium source is actually contained in the fertilizer.

Whenever reference is made throughout this document to a compound which is a salt, this should be construed to include the anhydrous form as well as any solvates (in particular hydrates) of this compound, unless explicitly defined otherwise. For example, whenever compound B or compound C is referenced, this includes the anhydrous form as well as any solvates (in particular hydrates) thereof, unless explicitly defined otherwise. Whenever reference is made herein to the concentration of a salt, this includes the weight of any solvated molecules (in particular water of hydration) if the compound is provided in the form of a solvate (in particular hydrate).

In a first aspect of the present invention there is provided a method for the production of a thiosulfate comprising the steps of
(i) providing a thiosulfate A represented by formula (X)ₙ(S₂O₃)ₘ;
(ii) providing a compound B represented by formula (Y)ₒ(Z)ₚ;
(iii) contacting the thiosulfate A of step (i) with the compound B of step (ii) in the presence of a solvent, thereby obtaining a reaction mixture comprising a compound C represented by formula (X)_{q}(Z)ᵣ and a thiosulfate D represented by formula (Y)ₛ(S₂O₃)ₜ;
wherein the ratio of the solubility of the thiosulfate D in the solvent at a predetermined temperature to the solubility of the compound C in the solvent at the same predetermined temperature is at least 5:1 or less than 1:5;
wherein n, m, o, p, q, r, s and t are each an integer individually selected from 1, 2, 3 and 4;
wherein X represents one or more cations with charge number +1, +2 or +3 and n and m are such that the overall charge of thiosulfate A is zero;
wherein Y represents one or more cations with charge number +1, +2 or +3, Z represents one or more anions with charge number −1, −2, or −3 and o and p are such that the overall charge of compound B is zero;
wherein X and Y are different;
wherein q and r are such that the overall charge of compound C is zero; and
wherein s and t are such that the overall charge of thiosulfate D is zero.

The method of the present invention prescribes that the ratio of the solubility of the thiosulfate D in the solvent at a predetermined temperature to the solubility of the compound C in the solvent at the same predetermined temperature is at least 5:1 or less than 1:5. As will be understood by the skilled person, since the solubility of thiosulfate D has at least a factor 5 difference from the solubility of the compound C at a predetermined temperature, facile separation of the thiosulfate D from the compound C is enabled. Preferably the ratio of the solubility of the thiosulfate D in the solvent at a predetermined temperature to the solubility of the compound C in the solvent at the same predetermined temperature is at least 10:1 or less than 1:10, preferably it is at least 50:1 or less than 1:50.

In preferred embodiments of the invention, the ratio of the solubility of the thiosulfate D in the solvent at a predetermined temperature to the solubility of the compound C in the solvent at the same predetermined temperature is at least 5:1, preferably at least 10:1, more preferably at least 50:1, most preferably at least 100:1. This allows the desired thiosulfate D to be obtained in solution, while the compound C precipitates, which is advantageous as thiosulfates are usually employed as liquid fertilizers and thus the liquid product resulting from the present method could be directly used by a grower without requiring further manipulation. Additionally, as most thiosulfates have a high water solubility, if an aqueous solvent (or simply water) is employed this will be the most commonly applicable method. In preferred embodiments the predetermined temperature is 25° C. since if a significant solubility difference exists at 25° C., separation of compound C and desired thiosulfate D using a solid-liquid separation will be possible at regular ambient temperatures. However, solid-liquid separation performed at elevated temperatures of the reaction mixture (e.g. more than 40° C. or more than 60° C.) or performed at reduced temperatures of the reaction mixture (e.g. less than 15° C., less than 5° C.) is also explicitly envisaged. Hence, in some embodiments of the invention the predetermined temperature is 60° C. since if a significant solubility difference exists at 60° C., separation of compound C and desired thiosulfate D using a solid-liquid separation will be possible at regular elevated temperatures. In other embodiments of the invention the predetermined temperature is 5° C. since if a significant solubility difference exists at 5° C., separation of compound C and desired thiosulfate D using a solid-liquid separation will be possible at reduced temperatures. It is preferred that the methods described herein are provided wherein step (iii) is performed at a reaction mixture temperature which is within a temperature ranging from 20° C. below the predetermined temperature to 20° C. above the predetermined temperature, preferably within a temperature ranging from 10° C. below the predetermined temperature to 10° C. above the predetermined temperature, more preferably within a temperature ranging from 5° C. below the predetermined temperature to 5° C. above the predetermined temperature

In view of the instability of thiosulfates, the pH in the reaction mixture is preferably controlled to be more than 5, preferably within the range of 5-9. This pH will be achieved without the need for pH adjustments for most embodiments of the method of the present invention, unless significant amounts of other compounds than the thiosulfate A and compound B are added to the reaction mixture. Hence, in preferred embodiments of the invention the combined amount of thiosulfate A, compound B, compound C and thiosulfate D in the reaction mixture of step (iii) is more than 80 wt. % (by total weight of the reaction mixture excluding solvent), preferably more than 90 wt. %, more preferably more than 95 wt. %.

With the exception of some minerals, n, m, o, p, q, r, s and t are typically each an integer individually selected from 1, 2, and 3, in particular from 1 and 2.

Y optionally represents a chelated cation. In some embodiments Y is not chelated, while in other embodiments Y is chelated. There are one or more advantages of proving Y in the form of a chelated cation, including stabilizing a compound and the oxidation state of the transition metal cation (thereby avoiding reaction with the thiosulfate ion, in particular in case Y represents an iron cation), as well as enhancing water solubility of the compound. If Y represents a chelated cation, Y preferably represents a chelated d-block ion, in particular a chelated cation selected from the group consisting of Manganese(I) (Mn⁺), Manganese(II) (Mn²⁺), Manganese(III) (Mn³⁺), Iron(II) (Fe²⁺), Iron(III) (Fe³⁺), Nickel(I) (Ni⁺), Nickel(II) (Ni²⁺), Nickel(III) (Ni³⁺), Copper(I) (Cu⁺), Copper(II) (Cu²⁺), Copper(III) (Cu³⁺), Cobalt(I) (Co⁺), Cobalt(II) (Co²⁺), Cobalt(III) (Co³⁺), Chromium(III) (Cr³⁺), Zinc(I) (Zn⁺), Zinc(II) (Zn²⁺), Molybdenum(I) (Mo⁺), Molybdenum(II) (Mo²⁺), Molybdenum(III) (Mo³⁺), and combinations thereof, preferably selected from Manganese(I) (Mn⁺), Manganese(II) (Mn²⁺), Manganese(III) (Mn³⁺), Iron(II) (Fe²⁺), Iron(III) (Fe³⁺), Nickel(I) (Ni⁺), Nickel(II) (Ni²⁺), Nickel(III) (Ni³⁺), Cobalt(I) (Co⁺), Cobalt(II) (Co²⁺), Cobalt(III) (Co³⁺), Molybdenum(I) (Mo⁺), Molybdenum(II) (Mo²⁺), Molybdenum(III) (Mo³⁺), and combinations thereof, most preferably Iron(II) (Fe²⁺), Iron(III) (Fe³⁺), and combinations thereof. As will be understood by the skilled person, in the embodiments of the invention wherein Y represents a chelated cation, in order to preserve charge neutrality, the reaction mixture will typically further comprise one or more further cations selected from the group consisting of alkali metals, alkaline earth metals and combinations thereof, in particular the reaction mixture will typically further comprise sodium (Na⁺) and/or potassium (K⁺), preferably potassium (K⁺). The chelant is preferably selected from the group consisting of aminocarboxylates and aminopolycarboxylates, preferably selected from aminocarboxylates and aminopolycarboxylates having 1-4 amine groups and 1-5 carboxylate groups, preferably selected from lysinate, glycinate, iminodiacetate (IDA), nitriloacetate (NTA), ethylenediaminetetracetate (EDTA), diethylenetriaminepentacetate (DTPA), Ethylene glycol-bis(β-aminoethyl ether)-N,N,N′,N′-tetracetate (EGTA), and combinations thereof, more preferably selected from glycinate, ethylenediaminetetracetate (EDTA), diethylenetriaminepentacetate (DTPA), and combinations thereof, most preferably ethylenediaminetetracetate (EDTA). Hence, it will be understood that embodiments wherein Y represents a chelated cation selected from Iron(II) (Fe²⁺), Iron(III) (Fe³⁺), and combinations thereof and wherein the chelant is EDTA are explicitly envisaged. It is preferred that Z represents a sulfate (SO₄²⁻). The chelated cation may be prepared in-situ. Non limiting examples of the compound B provided in step (II) of the method described herein, when chelants are used as described above, are the following embodiments:
EDTA-chelated iron(II) sulfate;
EDTA-chelated iron (III) sulfate.

In preferred embodiments of the invention, Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻) C₁-C₈ organic carboxylates, and combinations thereof, preferably Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻), oxalate (C₂O₄²⁻), benzoate (PhCO₂⁻), acetate (CH₃CO₂⁻), and combinations thereof, more preferably Z represents an anion selected from the group consisting of hydroxide (OH⁻), sulfate (SO₄²⁻) and combinations thereof, most preferably Z represents sulfate (SO₄²⁻).

In preferred embodiments of the invention X represents an alkali metal ion, an alkaline earth metal ion and/or an optionally chelated d-block ion, preferably, X represents an alkali metal ion, an alkaline earth metal ion and/or a d-block ion, more preferably X represents an alkali metal ion and/or an alkaline earth metal ion, more preferably X represents calcium (Ca²⁺) and/or magnesium (Mg²⁺), most preferably X represents calcium (Ca²⁺). If X represents calcium (Ca²⁺), this means the thiosulfate A is calcium thiosulfate (CaS₂O₃).

In preferred embodiments of the invention Y represents an alkali metal ion, an alkaline earth metal ion, and/or an optionally chelated d-block ion, preferably Y represents an alkali metal ion, an alkaline earth metal ion, and/or a d-block ion, preferably Y represents an alkali metal ion, an alkaline earth metal ion and/or a d-block ion which is not calcium (Ca²⁺).

In preferred embodiments of the invention Y represents a cation selected from the group consisting of Sodium (Na⁺), Potassium (K⁺), Magnesium (Mg²⁺), Manganese(I) (Mn⁺), Manganese(II) (Mn²⁺), Manganese(III) (Mn³⁺), Iron(II) (Fe²⁺); Iron(III) (Fe³⁺), Nickel(I) (Ni⁺), Nickel(II) (Ni²⁺), Nickel(III) (Ni³⁺), Copper(I) (Cu⁺), Copper(II) (Cu²⁺), Copper(III) (Cu³⁺), Cobalt(I) (Co⁺), Cobalt(II) (Co²⁺), Cobalt(III) (Co³⁺), Chromium(III) (Cr³⁺), Zinc(I) (Zn⁺), Zinc(II) (Zn²⁺), Molybdenum(I) (Mo⁺), Molybdenum(II) (Mo²⁺), Molybdenum(III) (Mo³⁺), and combinations thereof, preferably wherein Y represents a cation selected from the group consisting of Sodium (Na⁺), Potassium (K⁺), Magnesium (Mg²⁺), Manganese(II) (Mn²⁺), Iron(II) (Fe²⁺), Nickel(II) (Ni²⁺), Copper(II) (Cu²⁺), Cobalt(II) (Co²⁺), Zinc(II) (Zn²⁺), Molybdenum(II) (Mo²⁺), and combinations thereof. The skilled person will understand that Y can be a combination of the recited cations for example in the case of minerals. Hence in some embodiments of the invention, compound B is a mineral, preferably a sulfate mineral, such as langbeinite K₂Mg₂(SO₄)₃, polyhalite (K₂Ca₂Mg(SO₄)₄·2H₂O), kainite (KMg(SO₄)·Cl·3H₂O), picromerite (K₂SO₄·MgSO₄·6H₂O; also written as K₂Mg(SO₄)₂·6H₂O), leonite (K₂SO₄·MgSO₄·4H₂O; also written as K₂Mg(SO₄)₂·4H₂O) and/or aphthitalite (K₃Na(SO₄)₂), preferably langbeinite K₂Mg₂(SO₄)₃. A preferred combination is that wherein compound B is a mineral, preferably a sulfate mineral as described before, and wherein X represents calcium (Ca²⁺).

In particularly preferred embodiments of the invention Y represents Magnesium (Mg²⁺). As will be understood by the skilled person, if Y represents Magnesium (Mg²⁺) and Z represents sulfate (SO₄²⁻), o and p are 1, such that in accordance with the preferred embodiments described herein compound B is simply magnesium sulfate. As explained herein elsewhere, embodiments are explicitly envisaged wherein compound B is provided in anhydrous form and/or in the form of a solvate (e.g. a hydrate). Hence, in case compound B is magnesium sulfate, the magnesium sulfate can be provided as anhydrous magnesium sulfate, as magnesium sulfate monohydrate, or as magnesium sulfate heptahydrate. The heptahydrate form is most preferred. As is shown in the examples, it was found that the reaction of magnesium sulfate heptahydrate with a thiosulfate (calcium sulfate) is slightly endothermic, while for the anhydrous form reaction mixture temperature increases up to 60-70° C. The endothermic reaction achieved with the heptahydrate presents less safety issues and results in less equipment wear, while not being so endothermic that heating is required.

In other preferred embodiments of the invention Y represents a compound of formula (NRR′R″R″′)⁺ wherein R, R′, R″ and R″′ are each independently selected from the group consisting of H, alkyls and alkenyls, preferably from the group consisting of H, methyl, ethyl and propyl, most preferably R, R′, R″ and R″′ are each H. When R, R′, R″ and R″′ are each H, Y represents ammonium (NH₄⁺). As will be understood by the skilled person, if Y represents ammonium (NH₄⁺) and Z represents sulfate (SO₄²⁻), o is 2 and p is 1, such that in accordance with the preferred embodiments described herein compound B is simply ammonium sulfate.

In some preferred embodiments of the invention, X represents calcium (Ca²⁺), Y represents an alkali metal ion, an alkaline earth metal ion and/or a d-block ion which is not calcium (Ca²⁺), and Z represents sulfate (SO₄²⁻). This advantageously allows calcium sulfate (mostly in the form of the dihydrate, which is synthetic gypsum) to be recovered, a useful product which has various end-uses.

In other preferred embodiments of the invention, X represents potassium (K⁺) and/or magnesium (Mg²⁺), Y represents an alkali metal ion, preferably potassium (K⁺) and Z represents hydroxide (OH⁻). An example of this embodiments is when thiosulfate A is K₂Mg(S₂O₃)₂ and compound B is potassium hydroxide. In such an embodiment, magnesium hydroxide is obtained which is useful in waste water treatment.

The solvent employed in step (iii) may be any solvent wherein a significant solubility difference as prescribed in the method of the invention can be identified. Suitable examples are aqueous solvents or organic solvents. In some embodiments the organic solvents are selected from the group consisting of C₁-C₆ alkyls, C₁-C₆ alkyl alcohols, ethyl acetate, and combinations thereof, such as methanol, ethanol, isopropanol and combinations thereof. In preferred embodiments of the invention, the solvent comprises water, preferably the solvent comprises more than 50 wt. % (by total weight of the solvent) of water, more preferably the solvent comprises more than 90 wt. % (by total weight of the solvent) of water, most preferably the solvent consists essentially of water.

In preferred embodiments of the invention, step (iii) comprises mixing the thiosulfate A, the compound B and the solvent, preferably mixing by means of a stirred-tank mixer or an in-line mixer. It is preferred that mixing is performed for at least 15 minutes, preferably for at least 30 minutes. While the inventors have found that a precipitate of compound C may form instantaneously upon contacting the thiosulfate A with the compound B, the yield of the salt metathesis reaction can be significantly increased if reaction time is increased.

In preferred embodiments of the invention step (iii) is performed such that a major amount of compound C precipitates while a major amount of thiosulfate D is dissolved, preferably wherein more than 80 wt. % of the formed compound C precipitates while more than 80 wt. % of the formed thiosulfate D is dissolved. As will be understood by the skilled person and a prescribed by the method described herein, there is a predetermined temperature at which a significant solubility difference in the solvent can be identified. Hence, as is shown in the appended examples, performing step (iii) such that a major amount of compound C precipitates while a major amount of thiosulfate D is dissolved may comprise performing step (iii) at an appropriate temperature, and employing appropriate concentrations. As will be understood by the skilled person, if the concentrations are too low, both compound C and thiosulfate D may simply dissolve, while if the concentrations are too high, they may both precipitate.

In preferred embodiments of the invention step (iii) is performed at an (initial) concentration of thiosulfate A within the range of 2-55 wt. % (by total weight of the reaction mixture), preferably within the range of 8-35 wt. %, more preferably within the range of 15-25 wt. % and at an (initial) concentration of compound B within the range of 1-40 wt. % (by total weight of the reaction mixture), preferably within the range of 5-30 wt. %, more preferably within the range of 10-20 wt. %.

In preferred embodiments the invention further comprises a step:
(iv) submitting the reaction mixture of step (iii) to a solid-liquid separation resulting in a solid fraction comprising compound C and a liquid fraction comprising thiosulfate D or resulting in a solid fraction comprising thiosulfate D and a liquid fraction comprising compound C.

More preferably the invention further comprises a step:
(iv) submitting the reaction mixture of step (iii) to a solid-liquid separation resulting in a solid fraction comprising compound C and a liquid fraction comprising thiosulfate D.

Preferably, step (iv) is performed such that
the ratio (w/w) of compound C to thiosulfate D in the solid fraction is more than 5:1, preferably more than 10:1, more preferably more than 15:1; and
the ratio (w/w) of thiosulfate D to compound C in the liquid fraction is more than 5:1, preferably more than 10:1, more preferably more than 15:1.

The efficiency of separating compound C and thiosulfate D (and thus achieving the ratios described above for the solid and the liquid fraction) is mostly dependent on temperature, concentration and mechanical factors such as filter pore size in case filtration is performed. If reagents and solvents are such that the method as described herein is complied with, separation should be straightforward, as there is a temperature where there is a large solubility difference which can be exploited. This is shown in the appended examples.

The solid-liquid separation of step (iv) may be effected by any suitable solid-liquid separation techniques known in the art, such as (but not limited to) decanting, filtration and/or centrifugation. Filtration is a preferred separation technique, in view of its ease of use and low cost, in particular cross-flow filtration. Suitable filters include filters with a pore size of less than 50 micron, preferably less than 30 micron.

The solid-liquid separation of step (iv) is typically performed at a reaction mixture temperature within the range of 15-40° C. However, solid-liquid separation performed at higher temperatures of the reaction mixture (e.g. more than 40° C. or more than 60° C.) or performed at lower temperatures of the reaction mixture (e.g. less than 15° C., less than 5° C.) is also explicitly envisaged. It is within the routine capabilities of the skilled person, in view of the present disclosure, to determine the optimum temperature of the reaction mixture for performing solid-liquid separation, balancing the influence of temperature on solubility of the compound C and the desired thiosulfate D and thus efficiency of the separation, with energy consumption needs to apply heating and/or cooling.

In some embodiments, filtration is performed at a temperature of the reaction mixture of more than 40° C., preferably more than 60° C., and the concentration of thiosulfate D in the reaction mixture before filtration is higher than the solubility of thiosulfate D in the solvent at 25° C. The present inventors have found that by performing this hot filtration of an overconcentrated reaction mixture, solid thiosulfate D (e.g. magnesium thiosulfate in accordance with the preferred embodiments described herein elsewhere) can be efficiently and easily produced, since upon cooling of the filtrate, precipitates of thiosulfate D will form. This embodiment is especially preferred in case an anhydrous compound B, preferably an anhydrous sulfate (such as anhydrous magnesium sulfate) is provided in step (ii). Indeed, the exothermic reaction observed when performing the method of the present invention with anhydrous forms of compound B can sufficiently raise the reaction mixture temperature such that hot filtration can be performed without the need for additional heating means.

The pH of the liquid fraction is preferably within the range of 6-9, more preferably within the range of 7-8.5.

It is preferred that step (i) comprises providing the thiosulfate A in the form of a composition comprising more than 85 wt. % (by total weight of the composition excluding solvent) of the thiosulfate A, preferably more than 92 wt. % of the thiosulfate A, more preferably more than 96 wt. %. Similarly, it is preferred that step (i) comprises providing the compound B in the form of a composition comprising more than 85 wt. % (by total weight of the composition excluding solvent) of the compound B, preferably more than 92 wt. % of the compound B, more preferably more than 96 wt. %. As will be understood by the skilled person, by using high-purity forms of thiosulfate A and compound B are employed, a high-purity thiosulfate D can be obtained, which can be used as a fertilizer without requiring further purification.

Advantageously, the inventors have found that the method can be performed starting from liquid thiosulfate A, which is the form commonly available for agricultural uses. By starting from a commercially available liquid thiosulfate A, facile dosing is achieved and no extra manipulations, such as increasing concentration, is required. Hence in preferred embodiments of the invention the thiosulfate A has a solubility in the solvent at 25° C. of more than 10 g/100 ml, preferably of more than 25 g/100 ml and wherein step (i) comprises providing a solution, suspension or slurry of the thiosulfate A in solvent, preferably a solution of the thiosulfate A in solvent, wherein the solvent preferably comprises water, preferably the solvent comprises more than 50 wt. % (by total weight of the solvent) of water, more preferably the solvent comprises more than 90 wt. % (by total weight of the solvent) of water, most preferably the solvent consists essentially of water. Optionally, in this embodiment compound B has a solubility in the solvent at 25° C. of more than 10 g/100 ml, preferably of more than 25 g/100 ml and step (ii) comprises providing a solution, suspension or slurry of the compound B in solvent, preferably a solution of the compound B in solvent. However, compound B may also be provided as a solid.

In particularly preferred embodiments of the invention:
the thiosulfate A has a solubility in the solvent at 25° C. of more than 10 g/100 ml, preferably of more than 25 g/100 ml;
step (i) comprises providing a solution, suspension or slurry of the thiosulfate A in solvent, preferably a solution of the thiosulfate A in solvent, preferably step (i) comprises providing a 10-55 wt. % solution of the thiosulfate A in solvent, preferably a 20-40 wt. % solution, preferably a 20-30 wt. % solution;
the solvent comprises more than 50 wt. % (by total weight of the solvent) of water, more preferably the solvent comprises more than 90 wt. % (by total weight of the solvent) of water, most preferably the solvent consists essentially of water; and
more than 60 wt. % of the solvent employed in step (iii), preferably more than 80 wt. %, more preferably more than 90 wt. % originates from the solution, suspension or slurry of the thiosulfate A in solvent, preferably originates from the solution of the thiosulfate A in solvent provided in step (i).

This embodiment of the method of the invention allows the thiosulfate A to be provided in the form of commercially available liquid thiosulfate solutions, while low to none additional solvent needs to be added to perform the salt metathesis reaction. This has the additional advantage that the desired thiosulfate D is directly obtained in commercially relevant concentration without the need for an additional concentration or dilution step.

In some embodiments of the method of the present invention, the thiosulfate A is produced at the same manufacturing site or at a manufacturing site adjacent to the manufacturing site where step (iii) and optionally step (iv) are performed. In some embodiments, less than 30 wt. %, preferably less than 10 wt. % of the total weight of thiosulfate A produced annually at the thiosulfate A manufacturing site is converted to thiosulfate D via step (iii) of the method described herein.

In alternative embodiments of the method of the present invention, the thiosulfate A is produced at a remote manufacturing site from the manufacturing site where step (iii) and optionally step (iv) are performed. For example, the two sites can be removed by at least 10 km, preferably at least 50 km.

In another aspect of the invention, there is provided a composition obtainable from the method described herein. preferably there is provided the liquid fraction comprising thiosulfate D obtainable from the method described herein wherein step (iv) is performed.

In another aspect of the invention there is provided a liquid fertilizer preferably obtainable by the method described herein, comprising:
more than 10 wt. % (by total weight of the fertilizer) of the thiosulfate D, preferably more than 15 wt. %, most preferably more than 20 wt. %;
0.01-4 wt. % (by total weight of the fertilizer) of the thiosulfate A, preferably 0.1-4 wt. %, more preferably 0.5-3.5 wt. %, most preferably 1-3 wt. %, and
at least 50 wt. % (by total weight of the fertilizer solvent, preferably at least 65 wt. %.

In preferred embodiments, the combined amount of thiosulfate D and thiosulfate A is more than 80 wt. % (by total weight of the liquid fertilizer excluding solvent), preferably more than 90 wt. %, most preferably more than 95 wt. %.

The amount of thiosulfate D will typically be no more than 45 wt. % (by total weight of the fertilizer), preferably no more than 35 wt. %.

As will be understood by the skilled person, all embodiments described herein in the context of the method of the invention, for example relating to the identity of thiosulfate A, compound B, compound C and thiosulfate D and solvent are equally applicable to the fertilizer of the present invention.

In particular, the solvent preferably comprises more than 50 wt. % (by total weight of the solvent) of water, more preferably the solvent comprises more than 90 wt. % (by total weight of the solvent) of water, most preferably the solvent consists essentially of water

In particular, the thiosulfate D is represented by formula (Y)ₛ(S₂O₃)ₜ wherein s and t are each an integer individually selected from 1, 2, 3 and 4, and s and t are such that the overall charge of thiosulfate D is zero, wherein Y represents one or more cations with charge number +1, +2 or +3 and wherein Y preferably represents a cation selected from the group consisting of Sodium (Na⁺), Potassium (K⁺), Magnesium (Mg²⁺), Manganese(II) (Mn²⁺), Iron(II) (Fe²⁺), Nickel(II) (Ni²⁺), Copper(II) (Cu²⁺), Cobalt(II) (Co²⁺), Zinc(II) (Zn²⁺), Molybdenum(II) (Mo²⁺), ammonium (NH₄⁺) and combinations thereof, preferably Magnesium (Mg²⁺).

In particular, the thiosulfate A is represented by formula (X)ₙ(S₂O₃)ₘ wherein n and m are each an integer individually selected from 1, 2, 3 and 4, and n and m are such that the overall charge of thiosulfate A is zero, wherein X represents one or more cations with charge number +1, +2 or +3 different from Y, and wherein X preferably represents an alkali metal ion, an alkaline earth metal ion and/or a d-block ion, preferably an alkali metal ion and/or an alkaline earth metal ion, more preferably calcium (Ca²⁺).

The pH of the liquid fertilizer is preferably within the range of 6-9, more preferably within the range of 7-8.5.

In some embodiments, the liquid fertilizer is provided in the form of an aqueous solution, suspension or slurry.

As will have been understood based on the above description, particularly preferred embodiments of the invention are described by the following items.
1. A method for the production of a thiosulfate comprising the steps of
   (i) providing a thiosulfate A represented by formula (X)ₙ(S₂O₃)ₘ;
   (ii) providing a compound B represented by formula (Y)ₒ(Z)ₚ;
   (iii) contacting the thiosulfate A of step (i) with the compound B of step (ii) in the presence of a solvent, thereby obtaining a reaction mixture comprising a compound C represented by formula (X)_{q}(Z)ᵣ and a thiosulfate D represented by formula (Y)ₛ(S₂O₃)ₜ;
wherein the ratio of the solubility of the thiosulfate D in the solvent at a predetermined temperature to the solubility of the compound C in the solvent at the same predetermined temperature is at least 5:1 or less than 1:5;
wherein n, m, o, p, q, r, s and t are each an integer individually selected from 1, 2, 3 and 4;
wherein X represents one or more cations with charge number +1, +2 or +3 and n and m are such that the overall charge of thiosulfate A is zero;
wherein Y represents one or more cations with charge number +1, +2 or +3, Z represents one or more anions with charge number −1, −2, or −3 and o and p are such that the overall charge of compound B is zero;
wherein X and Y are different;
wherein q and r are such that the overall charge of compound C is zero; and
wherein s and t are such that the overall charge of thiosulfate D is zero.
2. The method of item 1 wherein Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻), C₁-C₈ organic carboxylates, and combinations thereof, preferably Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻), oxalate (C₂O₄²⁻), benzoate (PhCO₂⁻), acetate (CH₃CO₂⁻), and combinations thereof.
3. The method of item 2 wherein Z represents sulfate (SO₄²⁻).
4. The method of any one of items 1-3 wherein X and Y each independently represent an alkali metal ion, an alkaline earth metal ion and/or a d-block ion.
5. The method of item 4 wherein Y represents a cation selected from the group consisting of Sodium (Na⁺), Potassium (K⁺), Magnesium (Mg²⁺), Manganese(I) (Mn⁺), Manganese(II) (Mn²⁺), Manganese(III) (Mn³⁺), Iron(II) (Fe²⁺); Iron(III) (Fe³⁺), Nickel(I) (Ni⁺), Nickel(II) (Ni²⁺), Nickel(III) (Ni³⁺), Copper(I) (Cu⁺), Copper(II) (Cu²⁺), Copper(III) (Cu³⁺), Cobalt(I) (Co⁺), Cobalt(II) (Co²⁺), Cobalt(III) (Co³⁺), Chromium(III) (Cr³⁺), Zinc(I) (Zn⁺), Zinc(II) (Zn²⁺), Molybdenum(I) (Mo⁺), Molybdenum(II) (Mo²⁺), Molybdenum(III) (Mo³⁺), and combinations thereof, preferably wherein Y represents a cation selected from the group consisting of Sodium (Na⁺), Potassium (K⁺), Magnesium (Mg²⁺), Manganese(II) (Mn²⁺), Iron(II) (Fe²⁺), Nickel(II) (Ni²⁺), Copper(II) (Cu²⁺), Cobalt(II) (Co²⁺), Zinc(II) (Zn²⁺), Molybdenum(II) (Mo²⁺), and combinations thereof.
6. The method of item 5 wherein Y represents Magnesium (Mg²⁺) and Z represents sulfate (SO₄²⁻).
7. The method of item 6 wherein compound B is magnesium sulfate provided in the form of a hydrate, preferably the heptahydrate.
8. The method of any one of items 1-3 wherein Y represents a compound of formula (NRR′R″R″′)⁺ wherein R, R′, R″ and R″′ are each independently selected from the group consisting of H, alkyls and alkenyls, preferably from the group consisting of H, methyl, ethyl and propyl, most preferably R, R′, R″ and R″′ are each H.
9. The method according to any one of the previous items wherein the ratio of the solubility of the thiosulfate D in the solvent at a predetermined temperature to the solubility of the compound C in the solvent at the same predetermined temperature is at least 5:1, preferably at least 10:1, more preferably at least 50:1, most preferably at least 100:1; and wherein the predetermined temperature is 25° C.
10. The method according to any one of the previous items wherein step (iii) is performed at an (initial) concentration of thiosulfate A within the range of 2-55 wt. % (by total weight of the reaction mixture), preferably within the range of 8-35 wt. %, more preferably within the range of 15-25 wt. % and at an (initial) concentration of compound B within the range of 1-40 wt. % (by total weight of the reaction mixture), preferably within the range of 5-30 wt. %, more preferably within the range of 10-20 wt. %.
11. The method according to item 10, wherein the thiosulfate A has a solubility in the solvent at 25° C. of more than 10 g/100 ml, preferably of more than 25 g/100 ml and wherein step (i) comprises providing a solution, suspension or slurry of the thiosulfate A in solvent, preferably a solution of the thiosulfate A in solvent.
12. The method according to item 11 wherein more than 60 wt. % of the solvent employed in step (iii), preferably more than 80 wt. %, more preferably more than 90 wt. % originates from the solution, suspension or slurry of the thiosulfate A in solvent, preferably the solution of the thiosulfate A in solvent provided in step (i).
13. The method according to item 11 or 12 wherein step (i) comprises providing a 10-55 wt. % solution of the thiosulfate A in solvent, preferably a 20-40 wt. % solution, preferably a 20-30 wt. % solution, wherein the solvent comprises more than 50 wt. % (by total weight of the solvent) of water, more preferably the solvent comprises more than 90 wt. % (by total weight of the solvent) of water, most preferably the solvent consists essentially of water.
14. The method according to any one of the previous items further comprising a step:
   (iv) submitting the reaction mixture of step (iii) to a solid-liquid separation resulting in a solid fraction comprising compound C and a liquid fraction comprising thiosulfate D.
15. A liquid fertilizer comprising:
   more than 10 wt. % (by total weight of the fertilizer) of the thiosulfate D as described in any one of claims 1, 4-6, 8, preferably more than 15 wt. %, most preferably more than 20 wt. %;
   0.01-4 wt. % (by total weight of the fertilizer) of the thiosulfate A as described in any one of claims 1 and 3, preferably 0.1-4 wt. %, more preferably 0.5-3.5 wt. %, most preferably 1-3 wt. %, and
      at least 50 wt. % (by total weight of the fertilizer) solvent, preferably at least 65 wt. %.

### EXAMPLES

Filtration of the solids in the examples was performed using Whatman filter papers Grade 2 (8 μm); Grade 4 (20-25 μm), and Grade 42 (2.5 μm).

### Example 1: Production of Magnesium Thiosulfate from Calcium Thiosulfate and Anhydrous Magnesium Sulfate

To 158 grams of an aqueous calcium thiosulfate solution containing 0.25 moles or 38 grams of calcium thiosulfate is added 30 grams (0.25 moles) of dry and anhydrous magnesium sulfate with stirring in one portion. The temperature of the reaction rose to 60-70° C. A white solid formed immediately. The mixture was stirred for 48 hrs and the white precipitated removed by filtration thereafter. Liquid filtrate (aqueous solution of magnesium thiosulfate) was analyzed by iodine titration for its thiosulfate content and by Atomic Absorption Spectroscopy (AAS) for magnesium (Mg) and calcium (Ca) content. The solid precipitate (calcium sulfate, synthetic gypsum) was analyzed by AAS, after digestion in mixture of hydrochloric acid and nitric acid, for its calcium and magnesium contents. Sulfur is determined by the AOAC Method 980.02. The results are shown in the below table.

| mass of filtrate recovered | 65 | grams |
|---|---|---|
| mass of precipitate recovered | 72 | grams |
| wt. % magnesium in filtrate | 3.9 wt. % (22.5 wt. % as | |
| | MgS₂O₃) | |
| wt. % calcium in filtrate | 0.48 wt. % (1.8 wt. % as | |
| | CaS₂O₃) | |
| pH of filtrate | 7.39 | |
| Crystallization point (Salt Out | 21° F. (−6° C.) | |
| Temperature, SOT) | | |
| Specific gravity of filtrate | 1.24 | |
| S | 9.96 | wt. % |

As can be seen in the above table, the filtrate is a highly concentrated liquid solution of magnesium thiosulfate, with minor amounts of calcium thiosulfate which is directly usable as liquid fertilizer. The solid contains primarily calcium sulfate. The theoretical yield of calcium sulfate as anhydrous product should be 26 grams. The experimental yield is 72 grams. The excess weight (72−26=46) shows that the calcium sulfate is formed as dihydrate product (synthetic gypsum) and contains some excess moisture.

### Example 2: Production of Magnesium Thiosulfate from Calcium Thiosulfate and Anhydrous Magnesium Sulfate

Procedure similar to example 1 with the following differences. To 200 grams of an aqueous calcium thiosulfate solution containing 47.12 grams (0.31 moles) of calcium thiosulfate is added 37.3 grams (0.31 moles) of dry anhydrous magnesium sulfate with stirring and in one portion. The temperature rose to 60-70° C. After a few minutes stirring, the mixture is filtered hot and white solids are separated from the liquid filtrate. The results are shown in the below table.

| mass of filtrate recovered | 121.3 grams | (98 ml) |
|---|---|---|
| mass of precipitate recovered | 70 | grams |
| wt. % magnesium in filtrate | 3.81 wt. % (22.43 wt. % as | |
| | MgS₂O₃) | |
| wt. % calcium in filtrate | 0.68 wt. % (2.3 wt. % as | |
| | CaS₂O₃) | |
| pH of filtrate | 7.90 | |
| Crystallization point (Salt Out | 21° F. | (−6° C.) |
| Temperature, SOT) | | |
| Specific gravity of filtrate | 1.24 | |
| S | 10.23 | wt. % |

As can be seen in the above table, the filtrate is a highly concentrated liquid solution of magnesium thiosulfate, with minor amounts of calcium thiosulfate which is directly usable as liquid fertilizer. Compared to experiment 1 it can be seen that filtration at elevated temperatures increases the calcium thiosulfate content of the filtrate.

### Example 3: Production of Magnesium Thiosulfate from Calcium Thiosulfate and Anhydrous Magnesium Sulfate

Procedure similar to example 1 with the following differences. To 304 grams of an aqueous solution of calcium thiosulfate containing grams parts by weight of calcium thiosulfate (0.48 moles) with stirring is added 57.6 grams of anhydrous dry magnesium sulfate in one portion. The temperature of the reaction rose to 60-70° C. The reaction mixture is stirred for one hour and then the solid precipitate is removed by filtration. The results are shown in the below table.

| mass of filtrate recovered | 266 grams | (175 ml) |
|---|---|---|
| mass of precipitate recovered | 127 | grams |
| wt. % magnesium in filtrate | 4.09 wt. % (23.05 wt. % as | |
| | MgS₂O₃) | |
| wt. % calcium in filtrate | 0.35 wt. % (1.19 wt. % as | |
| | CaS₂O₃) | |
| pH of filtrate | 8.06 | |
| Crystallization point (Salt Out | 21° F. | (−6° C.) |
| Temperature, SOT) | | |
| Specific gravity of filtrate | 1.25 | |
| S | 10.12 | wt. % |

### Example 4: Production of Magnesium Thiosulfate from Calcium Thiosulfate and Magnesium Sulfate Monohydrate

Procedure similar to example 1 with the following differences. To 304 grams of an aqueous solution of calcium thiosulfate containing 73 grams of calcium thiosulfate (0.48 moles) with stirring is added 66.24 grams (0.48 moles) of magnesium sulfate mono hydrate in one portion. The temperature of the reaction rose to 40-45° C. The reaction mixture is stirred for one hour and then the solid precipitate is removed by filtration. The results are shown in the below table.

| mass of filtrate recovered | 205 grams | (170 ml) |
|---|---|---|
| mass of precipitate recovered | 104 | grams |
| wt. % magnesium in filtrate | 4.39 wt. % (22 wt. % as | |
| | MgS₂O₃) | |
| wt. % calcium in filtrate | 0.37 wt. % (1.19 wt. % as | |
| | CaS₂O₃) | |
| pH of filtrate | 8.20 | |
| Crystallization point (Salt Out | 29° F. | (−1.6° C.) |
| Temperature, SOT) | | |
| Specific gravity of filtrate | 1.238 | |
| S | 10.32 | wt. % |

### Example 5: Production of Magnesium Thiosulfate from Calcium Thiosulfate and Magnesium Sulfate Heptahydrate

Procedure similar to example 1 with the following differences. To 304 grams of an aqueous solution of calcium thiosulfate containing 73 grams of calcium thiosulfate (0.48 moles) with stirring is added 118 grams (0.48 moles) magnesium sulfate heptahydrate in one portion. The temperature of the reaction dropped to 15-20° C. The reaction mixture is stirred for one hour and then the solid precipitate is removed by filtration. The results are shown in the below table.

| mass of filtrate recovered | 204 grams | (168 ml) |
|---|---|---|
| mass of precipitate recovered | 103 | grams |
| wt. % magnesium in filtrate | 3.45 wt. % (18.5 wt. % as | |
| | MgS₂O₃) | |
| wt. % calcium in filtrate | 0.34 wt. % (1.19 wt. % as | |
| | CaS₂O₃) | |
| pH of filtrate | 7.54 | |
| Crystallization point (Salt Out | 30° F. | (−1.1° C.) |
| Temperature, SOT) | | |
| Specific gravity of filtrate | 1.203 | |
| S | 10.12 | wt. % |

A similar test was performed wherein the calcium thiosulfate solution was heated to 40-45° C. before addition of magnesium sulfate heptahydrate, with similar results.

### Example 6: Production of Manganese Thiosulfate from Calcium Thiosulfate and Manganese Sulfate Monohydrate

To 152 grams of an aqueous calcium thiosulfate solution containing 0.24 moles or 36.48 grams of calcium thiosulfate is added 40.5 grams (0.24 moles) of dry manganese sulfate monohydrate with stirring in small portions. A white solid formed. The mixture was stirred for 2 hrs and the white precipitated removed by filtration thereafter. The slightly pink liquid filtrate (aqueous solution of manganese thiosulfate) was analyzed by iodine titration for its thiosulfate content and by Atomic Absorption Spectroscopy (AAS) for manganese (Mn) and calcium (Ca) content. The solid precipitate (calcium sulfate, synthetic gypsum) was analyzed by AAS, after digestion in mixture of hydrochloric acid and nitric acid, for its calcium and manganese contents. Sulfur is determined by the AOAC Method 980.02. The results are shown in the below table.

| mass of filtrate recovered | 172 grams | (134 ml) |
|---|---|---|
| mass of precipitate recovered | 143 | grams |
| wt. % of thiosulfate by titration | 21.6 wt. percent | (7.12% Mn) |
| wt. % calcium in filtrate | 0.32% | |
| pH of filtrate | 5.74 | |
| Crystallization point (Salt Out | 24.8° F. | (−4° C.) |
| Temperature, SOT) | | |
| Specific gravity of filtrate | 1.287 | |
| S | 8.28 | wt. % |

### Example 7: Production of Zinc Thiosulfate from Calcium Thiosulfate and Zinc Sulfate Monohydrate

To 304 grams of an aqueous calcium thiosulfate solution containing 0.48 moles or 72.96 grams of calcium thiosulfate is added 86.1 grams (0.0.48 moles) of powdered zinc sulfate monohydrate (MW=179.47) with stirring in small portions. A white solid formed. The mixture was stirred for 2 hrs and the white precipitated removed by filtration thereafter. The liquid filtrate (aqueous solution of zinc thiosulfate) was analyzed by iodine titration for its thiosulfate content and by Atomic Absorption Spectroscopy (AAS) for zinc (Zn) and calcium (Ca) content. The solid precipitate (calcium sulfate, synthetic gypsum) was analyzed by AAS, after digestion in mixture of hydrochloric acid and nitric acid, for its calcium and zinc contents. Sulfur is determined by the AOAC Method 980.02. The results are shown in the below table.

| mass of filtrate recovered | 276.23 grams | (225 ml) |
|---|---|---|
| mass of precipitate recovered | 146 | grams |
| wt. % of thiosulfate by titration | 23.1 wt. percent | (8.57% Zn) |
| wt. % calcium in filtrate | 0.323% | |
| pH of filtrate | 4.27 | |
| Crystallization point (Salt Out | 28.8° F. | (−1.8° C.) |
| Temperature, SOT) | | |
| Specific gravity of filtrate | 1.235 | |
| S | 8.4 | wt. % |

### Example 8: Production of EDTA-Chelated Iron Thiosulfate from EDTA (Sodium Salt), Iron Sulfate and Calcium Thiosulfate

The captioned synthesis was successfully performed by combining the reagents in water.

1. A method for the production of a thiosulfate comprising the steps of
(i) providing a thiosulfate A represented by formula (X)ₙ(S₂O₃)ₘ;
(ii) providing a compound B represented by formula (Y)ₒ(Z)ₚ;
(iii) contacting the thiosulfate A of step (i) with the compound B of step (ii) in the presence of a solvent, thereby obtaining a reaction mixture comprising a compound C represented by formula (X)_{q}(Z)ᵣ and a thiosulfate D represented by formula (Y)ₛ(S₂O₃)ₜ;
wherein the ratio of the solubility of the thiosulfate D in the solvent at a predetermined temperature to the solubility of the compound C in the solvent at the same predetermined temperature is at least 5:1 or less than 1:5;
wherein n, m, o, p, q, r, s and t are each an integer individually selected from 1, 2, 3 and 4;
wherein X represents one or more cations with charge number +1, +2 or +3 and n and m are such that the overall charge of thiosulfate A is zero;
wherein Y represents one or more cations with charge number +1, +2 or +3, Z represents one or more anions with charge number −1, −2, or −3 and o and p are such that the overall charge of compound B is zero;
wherein X and Y are different;
wherein q and r are such that the overall charge of compound C is zero; and
wherein s and t are such that the overall charge of thiosulfate D is zero.

2. The method of claim 1, wherein Y represents an alkali metal ion, an alkaline earth metal ion and/or an optionally chelated d-block ion

3. The method of claim 2, wherein Y represents an optionally chelated d-block ion.

4. The method of claim 3, wherein Y represents an optionally chelated cation selected from the group consisting of Manganese(I) (Mn⁺), Manganese(II) (Mn²⁺), Manganese(III) (Mn³⁺), Iron(II) (Fe²⁺); Iron(III) (Fe³⁺), Nickel(I) (Ni⁺), Nickel(II) (Ni²⁺), Nickel(III) (Ni³⁺), Copper(I) (Cu⁺), Copper(II) (Cu²⁺), Copper(III) (Cu³⁺), Cobalt(I) (Co⁺), Cobalt(II) (Co²⁺), Cobalt(III) (Co³⁺) Chromium(III) (Cr³⁺), Zinc(I) (Zn⁺), Zinc(II) (Zn²⁺), Molybdenum(I) (Mo⁺), Molybdenum(II) (Mo²⁺), Molybdenum(III) (Mo³⁺), and combinations thereof preferably selected from Manganese(I) (Mn⁺), Manganese(II) (Mn²⁺), Manganese(III) (Mn³⁺), Iron(II) (Fe²⁺), Iron(III) (Fe³⁺), Nickel(I) (Ni⁺), Nickel(II) (Ni²⁺), Nickel(III) (Ni³⁺), Cobalt(I) (Co⁺), Cobalt(II) (Co²⁺), Cobalt(III) (Co³⁺), Molybdenum(I) (Mo⁺), Molybdenum(II) (Mo²⁺), Molybdenum(III) (Mo³⁺), and combinations thereof, most preferably selected from Iron(II) (Fe²⁺), Iron(III) (Fe³⁺), and combinations thereof.

5. The method of claim 3 or 4, wherein Y is provided in the form of a chelated ion.

6. The method of claim 5 wherein Y is provided in the form of a chelated ion, wherein the chelant is selected from the group consisting of aminocarboxylates and aminopolycarboxylates.

7. The method of claim 6, wherein the chelant is selected from lysinate, glycinate, iminodiacetate (IDA), nitriloacetate (NTA), ethylenediaminetetracetate (EDTA), diethylenetriaminepentacetate (DTPA), Ethylene glycol-bis(β-aminoethyl ether)-N,N,N′,N′-tetracetate (EGTA), and combinations thereof, more preferably selected from glycinate, ethylenediaminetetracetate (EDTA), diethylenetriaminepentacetate (DTPA), and combinations thereof, preferably ethylenediaminetetracetate (EDTA).

8. The method of claim 7 wherein Y represents a chelated cation selected from Iron(II) (Fe²⁺), Iron(III) (Fe³⁺), and combinations thereof and wherein the chelant is EDTA.

9. The method of any one of claims 1-8 wherein Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻), C₁-C₈ organic carboxylates, and combinations thereof, preferably Z represents an anion selected from the group consisting of phosphate (PO₄³⁻), carbonate (CO₃²⁻), hydroxide (OH⁻), fluoride (F⁻), sulfite (SO₃²⁻), sulfate (SO₄²⁻), oxalate (C₂O₄²⁻), benzoate (PhCO₂⁻), acetate (CH₃CO₂⁻), and combinations thereof.

10. The method of any one of claims 1-9, wherein Z represents sulfate (SO₄²⁻).

11. The method of claim 10 wherein compound B is a mineral.

12. The method of claim 11 wherein compound B is a sulfate mineral.

13. The method of claim 12 wherein compound B is selected from langbeinite K₂Mg₂(SO₄)₃, polyhalite (K₂Ca₂Mg(SO₄)₄·2H₂O), kainite (KMg(SO₄)·Cl·3H₂O), picromerite (K₂SO₄·MgSO₄·6H₂O; also written as K₂Mg(SO₄)₂·6H₂O), leonite (K₂SO₄·MgSO₄·4H₂O; also written as K₂Mg(SO₄)₂·4H₂O) and/or aphthitalite (K₃Na(SO₄)₂), preferably langbeinite K₂Mg₂(SO₄)₃.

14. The method of claim 9 or 10, wherein Y represents a cation selected from the group consisting of Sodium (Na⁺), Potassium (K⁺), Magnesium (Mg²⁺), Manganese(I) (Mn⁺), Manganese(II) (Mn²⁺), Manganese(III) (Mn³⁺), Iron(II) (Fe²⁺); Iron(III) (Fe³⁺), Nickel(I) (Ni⁺), Nickel(II) (Ni²⁺), Nickel(III) (Ni³⁺), Copper(I) (Cu⁺), Copper(II) (Cu²⁺), Copper(III) (Cu³⁺), Cobalt(I) (Co⁺), Cobalt(II) (Co²⁺), Cobalt(III) (Co³⁺), Chromium(III) (Cr³⁺), Zinc(I) (Zn⁺), Zinc(II) (Zn²⁺), Molybdenum(I) (Mo⁺), Molybdenum(II) (Mo²⁺), Molybdenum(III) (Mo³⁺), and combinations thereof, preferably wherein Y represents a cation selected from the group consisting of Sodium (Na⁺), Potassium (K⁺), Magnesium (Mg²⁺), Manganese(II) (Mn²⁺), Iron(II) (Fe²⁺), Nickel(II) (Ni²⁺), Copper(II) (Cu²⁺), Cobalt(II) (Co²⁺), Zinc(II) (Zn²⁺), Molybdenum(II) (Mo²⁺), and combinations thereof.

15. The method of claim 14, wherein Y represents Magnesium (Mg²⁺) and Z represents sulfate (SO₄²⁻).

16. The method of claim 15, wherein compound B is magnesium sulfate provided in the form of a hydrate, preferably the heptahydrate.

17. The method of claim 14, wherein Y represents Potassium (K⁺) and Z represents sulfate (SO₄²⁻).

18. The method of any one of claims 1, 9 or 10, wherein Y represents a compound of formula (NRR′R″R″′)⁺ wherein R, R′, R″ and R″′ are each independently selected from the group consisting of H, alkyls and alkenyls, preferably from the group consisting of H, methyl, ethyl and propyl, most preferably R, R′, R″ and R″′ are each H.

19. The method of any one of the previous claims, wherein X represents an alkali metal ion, an alkaline earth metal ion and/or an optionally chelated d-block ion.

20. The method of claim 19, wherein X represents calcium (Ca²⁺).

21. The method of claim 20, wherein Z represents sulfate (SO₄²⁻).

22. The method of claim 19, wherein X represents potassium (K⁺) and/or magnesium (Mg²⁺).

23. The method of claim 22, wherein Y represents an alkali metal ion, preferably potassium (K⁺).

24. The method of claim 22 or 23, wherein Z represents hydroxide (OH⁻).

25. The method according to any one of the previous claims, wherein the ratio of the solubility of the thiosulfate D in the solvent at a predetermined temperature to the solubility of the compound C in the solvent at the same predetermined temperature is at least 5:1, preferably at least 10:1, more preferably at least 50:1, most preferably at least 100:1; and wherein the predetermined temperature is 25° C.

26. The method according to any one of the previous claims, wherein step (iii) is performed at an (initial) concentration of thiosulfate A within the range of 2-55 wt. % (by total weight of the reaction mixture), preferably within the range of 8-35 wt. %, more preferably within the range of 15-25 wt. % and at an (initial) concentration of compound B within the range of 1-40 wt. % (by total weight of the reaction mixture), preferably within the range of 5-30 wt. %, more preferably within the range of 10-20 wt. %.

27. The method according to claim 26, wherein the thiosulfate A has a solubility in the solvent at 25° C. of more than 10 g/100 ml, preferably of more than 25 g/100 ml and wherein step (i) comprises providing a solution, suspension or slurry of the thiosulfate A in solvent, preferably a solution of the thiosulfate A in solvent.

28. The method according to claim 27, wherein more than 60 wt. % of the solvent employed in step (iii), preferably more than 80 wt. %, more preferably more than 90 wt. % originates from the solution, suspension or slurry of the thiosulfate A in solvent, preferably the solution of the thiosulfate A in solvent provided in step (i).

29. The method according to claim 27 or 28, wherein step (i) comprises providing a 10-55 wt. % solution of the thiosulfate A in solvent, preferably a 20-40 wt. % solution, preferably a 20-30 wt. % solution, wherein the solvent comprises more than 50 wt. % (by total weight of the solvent) of water, more preferably the solvent comprises more than 90 wt. % (by total weight of the solvent) of water, most preferably the solvent consists essentially of water.

30. The method according to any one of the previous claims wherein the predetermined temperature is 25° C.

31. The method according to any one of the previous claims, further comprising a step:
(iv) submitting the reaction mixture of step (iii) to a solid-liquid separation resulting in a solid fraction comprising compound C and a liquid fraction comprising thiosulfate D.

32. A liquid fertilizer comprising:
more than 10 wt. % (by total weight of the fertilizer) of the thiosulfate D as described in any one of the previous claims, preferably more than 15 wt. %, most preferably more than 20 wt. %;
0.01-4 wt. % (by total weight of the fertilizer) of the thiosulfate A as described in any one of the previous claims, preferably 0.1-4 wt. %, more preferably 0.5-3.5 wt. %, most preferably 1-3 wt. %, and
at least 50 wt. % (by total weight of the fertilizer) solvent, preferably at least 65 wt. %.

33. The liquid fertilizer of claim 32 which is an aqueous solution, suspension or slurry.
